(19) United States
(12) Patent Application Publication
(10) Pub. No.: US 2024/0091631 A1
(43) Pub. Date: Mar. 21, 2024

(54) ANIMATED PUZZLE

(71) Applicants: Bradley N Litwin, Philadelphia, PA (US); Roger Dreyer, Wayne, NJ (US)

(72) Inventors: Bradley N Litwin, Philadelphia, PA (US); Roger Dreyer, Wayne, NJ (US)

(21) Appl. No.: 18/469,402

(22) Filed: Sep. 18, 2023

Related U.S. Application Data
(60) Provisional application No. 63/376,100, filed on Sep. 18, 2022.

(51) Int. Cl. A63F 9/10

(52) U.S. Cl. CPC A63F 9/10; A63F 2009/1061

(57) ABSTRACT

An animated puzzle and/or animated puzzle kit comprising at least two puzzle pieces and at least one animated component. The at least two puzzle pieces being configured into shapes that fit together to form an assembled puzzle. The assembled puzzle having at least one pre-determined pre-cut section for placement of the at least one animated component. At least one animating device being connected to the at least one animated component, whereby operation of the at least one animating device animates the at least one animated component.

### CROSS-REFERENCE TO RELATED APPLICATIONS

This application claims priority to, and incorporates in reference by its entirety, U.S. Application No. 63/376,100, filed Sep. 18, 2022, entitled Animated Puzzle.

### BACKGROUND OF THE INVENTION

The present invention relates to puzzles, specifically a new field combining puzzles and animated toys.

Presently there are no flat jigsaw puzzles with animated components without resort to digital animation. The present invention solves these problems and improves puzzles by combining them with animated toys.

Jigsaw puzzles have been a popular pastime for hundreds of years, offering a prolonged challenge to reconstruct a fanciful scene from hundreds of interlocking pieces. Completion is rewarded by having reconstituted a static, two-dimensional image. This invention offers an enhancement of such puzzles by added, animated mechanical elements.

### SUMMARY OF THE INVENTION

One embodiment of the animated puzzle comprises:
At least two puzzle pieces (or a plurality of puzzle pieces) and at least one animated component;
The at least two puzzle pieces being configured into shapes that fit together to form an assembled puzzle;
The assembled puzzle having at least one pre-determined pre-cut section for placement of the at least one animated component;
At least one animating device connected to the at least one animated component, whereby operation of the at least one animating device animates the at least one animated component.

In another embodiment, the animated puzzle, further comprises:
at least one support (e.g., a peg, pivot, etc.), the at least one support being attached to the at least one animated component; and
the at least one support being fitted into, sitting in, held, attached, located, and/or adjacent the at least one pre-determined pre-cut section of the assembled puzzle.

In another embodiment of the animated puzzle, the at least one animated component further comprises at least a first animated component and at least a second animated component, the at least first animated component being connected to the at least second animated component, whereby movement of the at least first animated component effects movement of the at least second animated component.

In another embodiment, the animated puzzle comprises:
At least two puzzle pieces (or a plurality of puzzle pieces) and at least one animated component;
The at least two puzzle pieces being configured into shapes that fit together to form an assembled puzzle;
A securing device, whereby puzzle pieces are secured to each other in the assembled puzzle when the animated component is added and/or animated;
The assembled puzzle having at least one pre-determined pre-cut section for placement of the at least one animated component;
At least one animating device connected to the at least one animated component, whereby operation of the at least one animating device animates the at least one animated component.

In another embodiment, the animated puzzle, further comprises:
at least one support, the at least one support being attached to the at least one animated component; and
the at least one support being fitted into, sitting in, held, attached, located, and/or adjacent the at least one pre-determined pre-cut section of the assembled puzzle.

In another embodiment of the animated puzzle, the at least one animated component further comprises at least a first animated component and at least a second animated component, the at least first animated component being connected to the at least second animated component, whereby movement of the at least first animated component effects movement of the at least second animated component.

In another embodiment of the animated puzzle, the securing device is a backer board or backing surface (the backer board or backing surface can have at least one pre-determined pre-cut section matching the at least one pre-determined pre-cut section in the assembled puzzle), the backer board having a pre-defined border for holding the assembled puzzle, the backer board having framing edges extending past the pre-defined border, the framing edges of the backer board being foldable over a portion of the puzzle pieces, whereby folding the framing edges of the backer board over a portion of the puzzle pieces forms a frame around the assembled puzzle, and the backer board being comprised of at least one piece.

Another embodiment of the animated puzzle further comprises stickers or adhesive for adhering the framing edges of the backer board to a portion of the puzzle pieces.

In another embodiment of the animated puzzle, the backer board is foldable into halves, thirds, quarters, fifths, etc. whereby it is smaller and less expensive for storage and transport. Similarly, the backer board can be in more than one piece which can be attached during use to form a single backer board, whereby it is smaller and less expensive for storage and transport

In another embodiment of the animated puzzle, the securing device is a sleeve (preferably the puzzle pieces and/or assembled puzzle is visible through the sleeve, preferably the sleeve is made of a material capable of such visibility, such as plastic, etc.) into which the assembled puzzle can be inserted, whereby the assembled puzzle pieces are held together. The sleeve can have pre-determined pre-cut sections which match those of the assembled puzzle, for placement of the at least one animated component, or the sleeve can be made of a material that is easily pierced so that animated components, and/or their associated parts, can be placed through it.

In another embodiment of the animated puzzle, the securing device is a slip-on frame comprised of framing pieces which slip on the edges on the animated puzzle to form a frame. When the assembled puzzle is on a backing board, the framing pieces squeeze together the backing board layer and the layer of the assembled puzzle.

In other embodiments of the animated puzzle, the securing device can be an adhesive, such as glue, tape, etc., for attaching the puzzle pieces to each other and/or for attaching the puzzle pieces to a substrate (i.e., an underlying layer), such as a sheet, board, backer board, etc.

In other embodiments of the animated puzzle, the securing device can be a reinforced

frame for the assembled puzzle pieces to sit in.

In another embodiment, the animated puzzle is a greeting card.

Another embodiment is an animated puzzle kit comprising:
At least two puzzle pieces (or a plurality of puzzle pieces), at least one animated component, at least one animating device, and a backing sheet or backer board;
The at least two puzzle pieces for forming an assembled puzzle on the backing sheet;
The assembled puzzle having at least one pre-determined pre-cut section for placement of the at least one animated component (the backing sheet can have at least one pre-determined pre-cut section matching the at least one pre-determined pre-cut section in the assembled puzzle); and

The at least one animating device being connected to the at least one animated component, whereby operation of the at least one animating device animates the at least one animated component.

In another embodiment, the animated puzzle kit further comprises at least one support; the at least one support carrying the at least one animated component on the assembled puzzle, the at least one support being adjacent the at least one pre-determined pre-cut section of the assembled puzzle.

In another embodiment, the animated puzzle kit further comprises at least two slip-on frame pieces;
The at least two slip-on frame pieces for slipping on the assembled puzzle and backing sheet, thereby holding together the assembled puzzle and backing sheet.

In another embodiment, the animated puzzle kit further comprises at least one connecting device;
The at least one animated component having at least a first animated component and a second animated component, the at least one connecting device for connecting at least the first animated component to at least the second animated component, whereby movement of the at least first animated component effects movement of the at least second animated component.

### BRIEF DESCRIPTION OF DRAWINGS

FIG. 1 is a top perspective view of an embodiment of the animated puzzle of the invention;

FIG. 2 is a top perspective view of an embodiment of the animated puzzle of the invention;

FIG. 3a is a perspective view of an embodiment of the animated puzzle of the invention;

FIG. 3b is a perspective view of an embodiment of the animated puzzle of the invention;

FIG. 4 is an exploded view showing an embodiment of the supporting structures;

FIG. 5 is a top plan view of an embodiment of the animated puzzle of the invention;

FIG. 6 is a top plan view of an embodiment of the animated puzzle of the invention;

FIG. 7 shows a top plan view of an alternative embodiment of a four-piece backer board;

FIG. 8A is a plan view of an embodiment of the animated puzzle of the invention;

FIG. 8B is a cross-section along line A-A of the plan view of FIG. 8A;

FIG. 9 is a top perspective view of an example of a backer board;

FIG. 10 is a top perspective view of an assembled animated puzzle;

FIG. 11 is an exploded view of an example of a backer board with support pieces;

FIG. 12 is an exploded view of an example of a backer board with support pieces;

FIG. 13 is an exploded view of an example of an assembly of connecting and supporting pieces;

FIG. 14 is an exploded view of an example of an assembly of an animating device in the form of a crank knob;

FIG. 15 is an exploded view of an example of a mounting of the animating device assembly;

FIG. 16 is a top plan view of some animated components;

FIG. 17 is a top plan view of some animated components; and

FIG. 18 is an exploded view showing how an animated component is assembled.

### DETAILED DESCRIPTION OF THE INVENTION

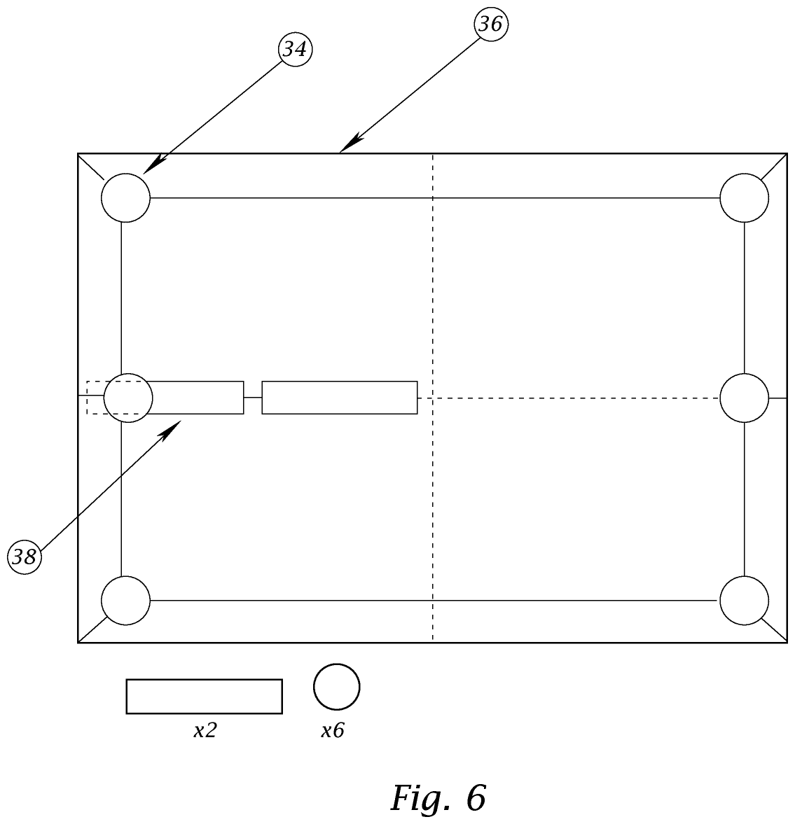

Components in the drawings:
1—assembled and/or partially assembled puzzle pieces
2—individual puzzle pieces
3—animated component, which can be a sticker, drawing, painting or other two- or three-dimensional representation of a character or shape to be animated/moved; substrate can be, by way of non-limiting example, plastic, wood, metal, suitable alternatives, etc.
4—connecting device
5—animated component, which can be a sticker, drawing, painting or other two- or three-dimensional representation of a character or shape to be animated/moved; substrate can be, by way of non-limiting example, plastic, wood, metal, suitable alternatives, etc.
6—backer board/backing sheet
7—structural support (in the form of pegs)
8—opening, can be pre-cut/perforated in individual puzzle pieces 2 so that assembled and/or partially assembled puzzle pieces 1 have a pre-cut/perforation for structural support 7, connecting device 4, animated component 3, 5, etc.
9—structural support, in the form of a slide plate (different embodiment from structural support 7)
10—animated component, which can be a sticker, drawing, painting or other two- or three-dimensional representation of a character or shape to be animated/moved; substrate can be, by way of non-limiting example, plastic, wood, metal, suitable alternatives, etc.
11—slot in plate 9
12—animated component, which can be a sticker, drawing, painting or other two- or three-dimensional representation of a character or shape to be animated/moved; substrate can be, by way of non-limiting example, plastic, wood, metal, suitable alternatives, etc.
13—pivot, also pivot connection point
14—pivot, also pivot connection point
15—pivot, also pivot connection point
16—pivot, also pivot connection point
17—pivot, also pivot connection point (the pivots are another type of support)
18—lines of linkages between pivot points 13 and 15 typified by dashed lines 18
19—lines of linkages between pivot points 14 and 16 typified by dashed lines 19
20—lines of linkages between pivot points 15 and 17 typified by dashed lines 20
21—animated component, which can be a sticker, drawing, painting or other two- or three-dimensional representation of a character or shape to be animated/moved; substrate can be, by way of non-limiting example, plastic, wood, metal, suitable alternatives, etc.
22—knob, as an example of an animating device
23—pin
24—flange
25—spacer
34—sticker(s) (by way of non-limiting example, use six as shown in FIG. 6)
36—back board edges
38 —back board support tape (by way of non-limiting example, use two as shown in FIG. 6)
40—pre-cut and/or perforated back board hole type 1
41—back board border with foldable line
42—foldable lines in back board
43—scored line in back board
45 —pre-cut and/or perforated back board hole type 2

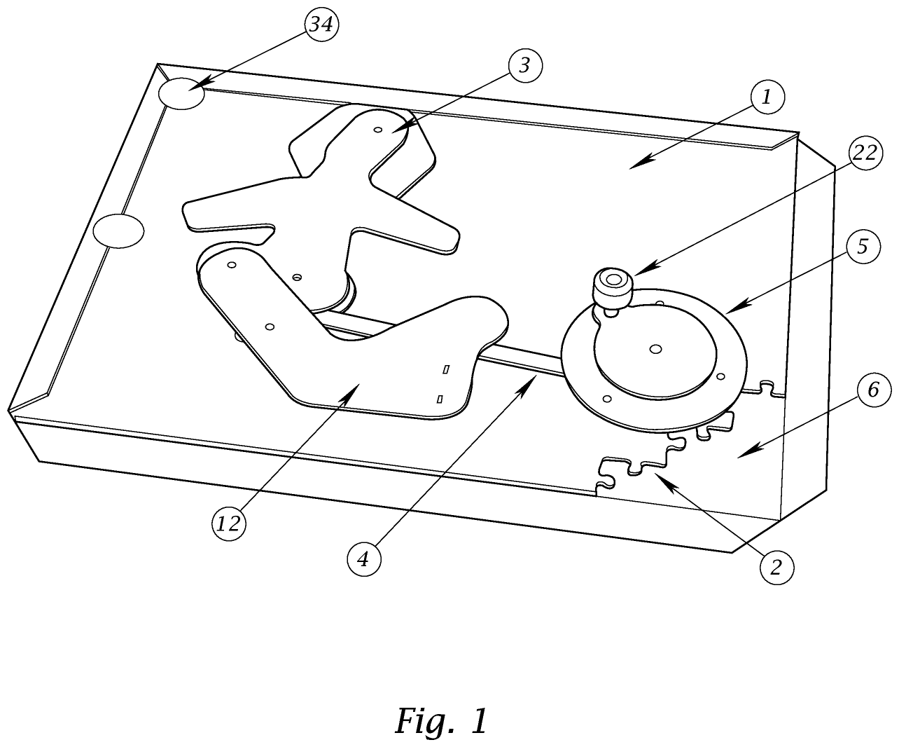

FIG. 1 is a top perspective view of an embodiment of the animated puzzle of the invention. Backer board 6 includes puzzle pieces 2 in a partially assembled state 1. Backer board edges, shown, but not numbered in FIG. 1, are shown open and partially covering partially assembled puzzle pieces 1, while being held in place with examples of stickers 34. Animated components 3, 5 and 12 are shown connected by connector device 4 and crank knob 22 is shown connected to animated component 5, whereby cranking/turning knob 22 can activate/animate animated component 5 and can move connector device 4 to activate/animate animated component 3 and/or 12.

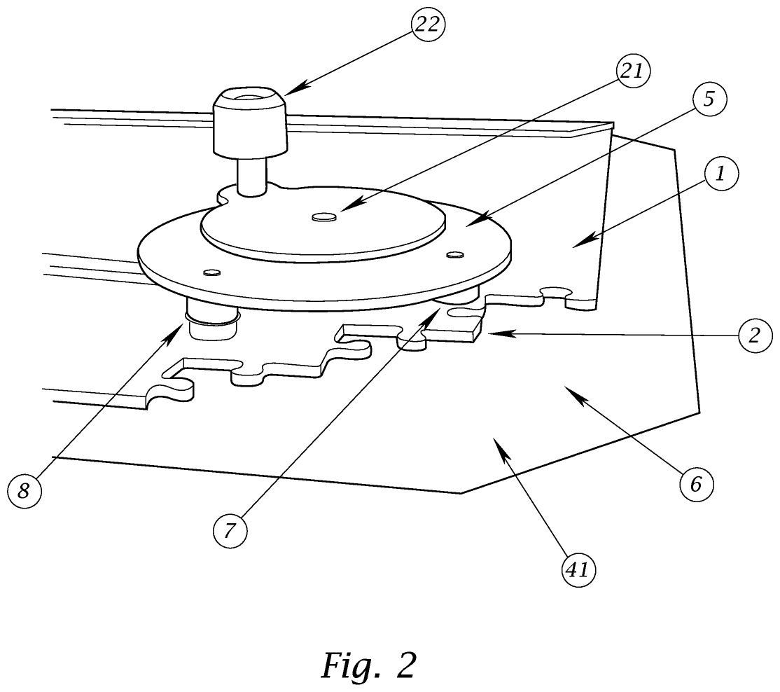

FIG. 2 is a top perspective view of an embodiment of the animated puzzle of the invention. Backer board 6 includes puzzle pieces 2 in a partially assembled state 1. Animated component 5 has joint support device 7 and puzzle pieces 2 are cut, pre-cut and/or perforated, resulting in partially assembled puzzle pieces 1 having hole 8 for joint support device 7. Backer board edges, shown, but not numbered in FIG. 2, are shown open and partially covering partially assembled puzzle pieces 1. Additionally, backer board border 41 is shown and it is shown that it can be pre-folded. Additionally, shown are animated component 21 and crank/knob 22.

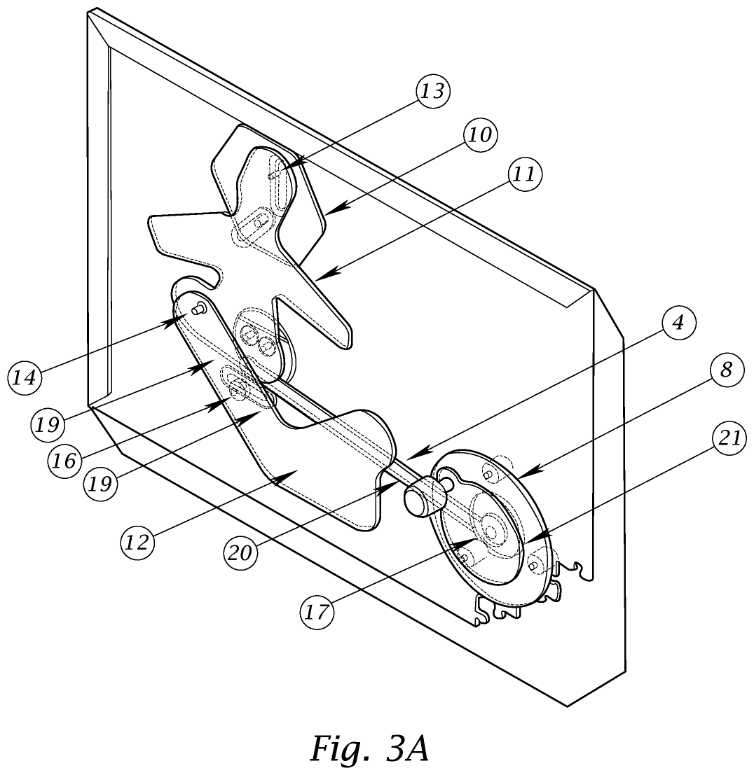

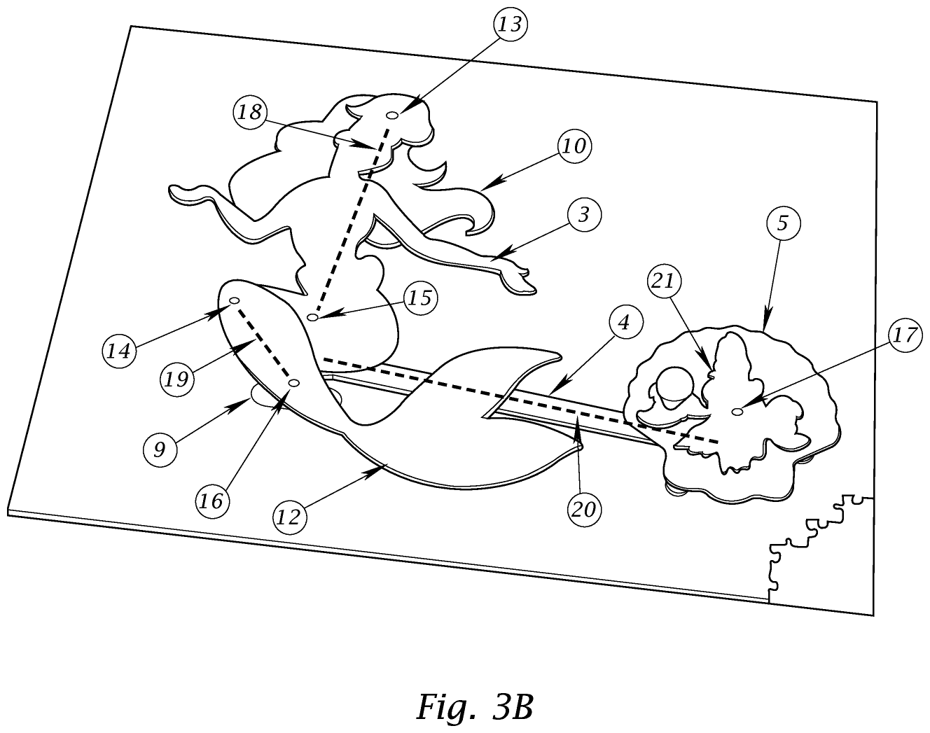

FIG. 3A is a perspective view of an embodiment of the animated puzzle of the invention.

FIG. 3B is also a perspective view of an embodiment of the animated puzzle of the invention. In both FIGS. 3A and 3B, animated components 5, 21 utilizes peg-type supporting structures 7, while animated components 10, 12 use pin 23 and/or slide plate 9 supporting structures.

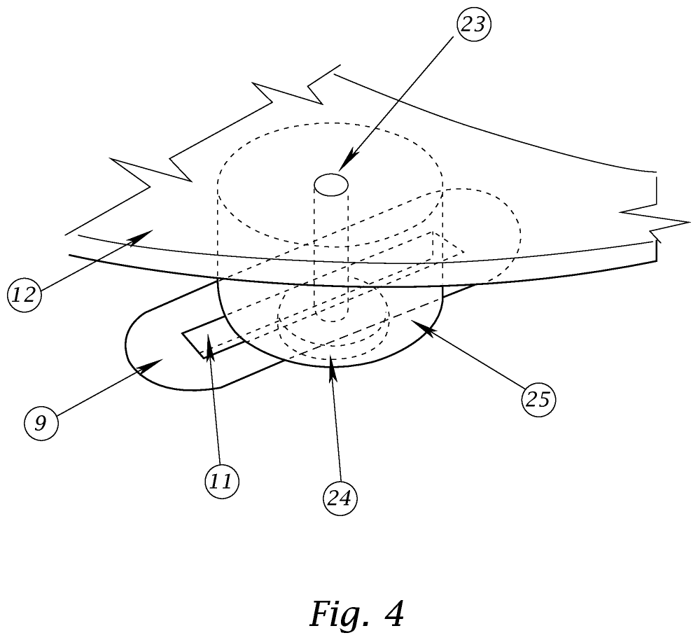

FIG. 4 is an exploded view showing an embodiment of the use of pin 23 and slide plate 9 supporting structures.

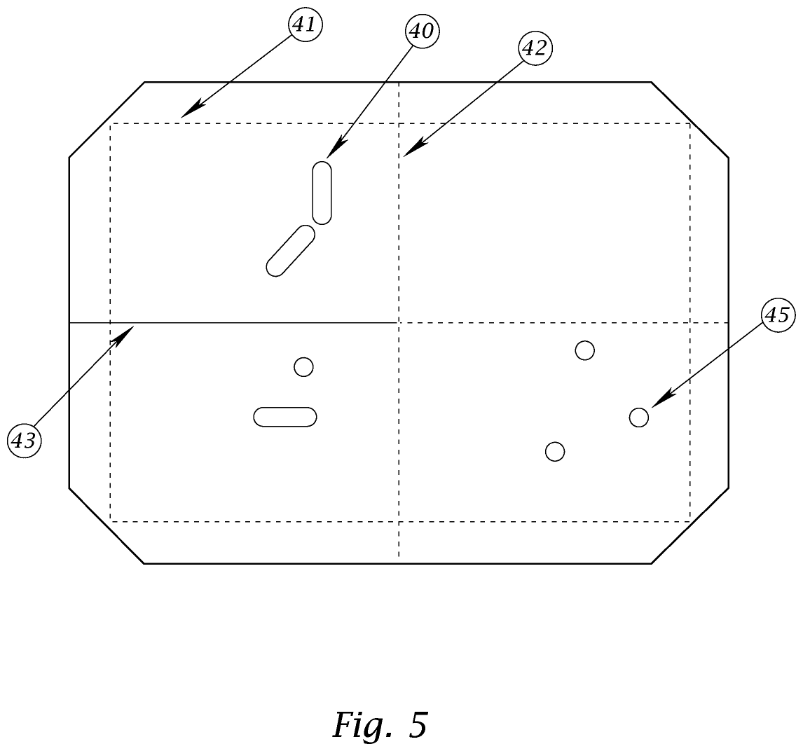

FIG. 5 is a top plan view of an embodiment of the animated puzzle of the invention. It shows backer board 6 which can be foldable in quarters, having three folding lines 42, and one pre-cut line 43 (which can be taped in place for extra support as shown in FIG. 6). Alternatively, backer board 6 can be foldable in halves, thirds, fifths or any other ratio, or it can be made not foldable at all. Making backer board 6 foldable makes it smaller to save space for transportation and storage, thus making it more economical. Backer board 6 can have border lines 41 which can be pre-folded or scored to make it easier to fold over the backer board edges, when backer board edges are used. Also, the border lines 41 easily show the boundaries for the assembled puzzle. Backboard 6 can have one or more type of pre-cut and/or perforated holes, shown here are two types: type 1: 40 and type 2: 45. In this example, each hole is customized for a particular support structure. Type 2, hole 45, is customized for peg support structure 7, while type 1, hole 40, is customized for slide plate support structure 9. Any type of hole is possible depending on the type of support structure being used.

FIG. 6 is a top plan view of an embodiment of the animated puzzle of the invention. It shows backer board 6 which can be foldable in quarters, having three folding lines 42, and one pre-cut line 43 which is taped in place for extra support using two pieces of tape 38, for example. It is not necessary to use tape 38, but the extra support it provides is beneficial. Also, the amount and type of adhesive or other support (e.g., staples, etc.) depends upon the type of backer board, supplies available to the user, etc. Also shown are all four backer board edges 36 folded over on top of an assembled puzzle 1 and held in place by stickers 34. In this example, six stickers 34 are used, but it is possible to use more or fewer stickers 34. Also, the stickers 34 can be in various shapes and/or characters. Alternatively, the inside of backer board edge 36, the surface folded over the top of an assembled or partially assembled puzzle 1, can include (in addition or instead of the stickers 34) adhesive, e.g., lick and stick, peel and stick, etc. (not shown) to help keep in place the backer board, puzzle pieces, animated components, supports, connections, etc.

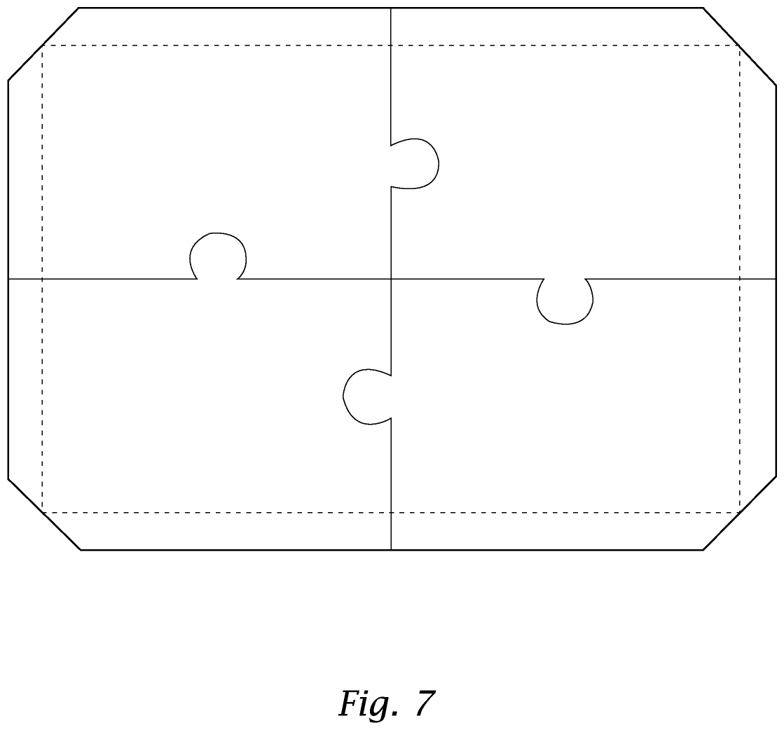

FIG. 7 shows a top plan view of an alternative embodiment of a four-piece backer board which is cut to fit together like puzzle pieces. Support tape 38 (not shown in this figure) can also be used to help keep these backer board pieces together. These backer board pieces can be adhered together by virtue of their being fitted together as puzzle pieces and/or by using glue, tape, staple(s), etc.

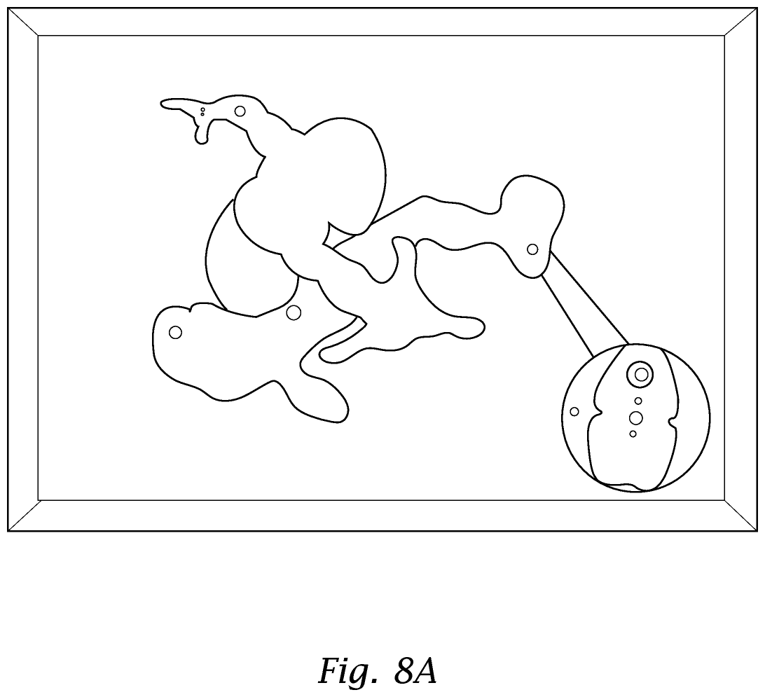

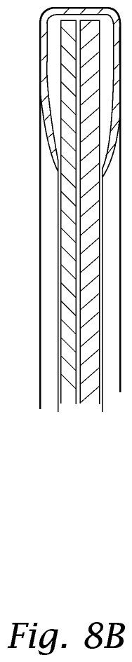

FIG. 8A shows a jigsaw puzzle with animated components and a slip-on frame.

FIG. 8B is a cross-sectional view along section A-A of FIG. 8A. It shows the slip-on frame squeezing together the puzzle layer and the backer board layer.

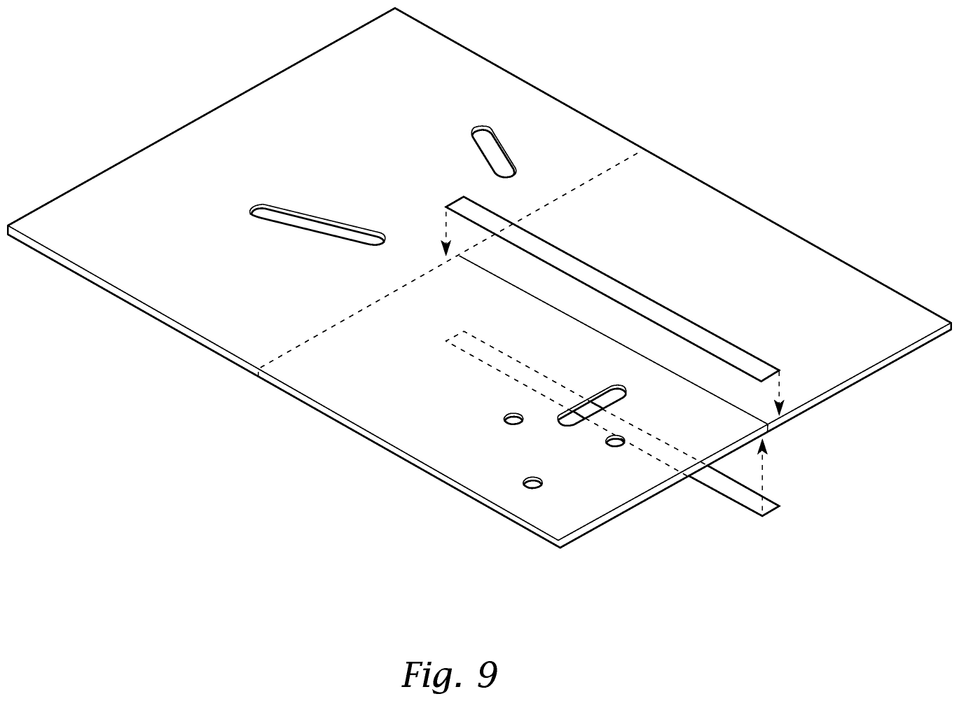

FIG. 9 shows a puzzle base board that has been unfolded for use with the split seam pointing to the right. It is possible to make the base board stronger by placing rectangular stickers over the slot in the base board. These stickers can be included on a sticker sheet in a kit.

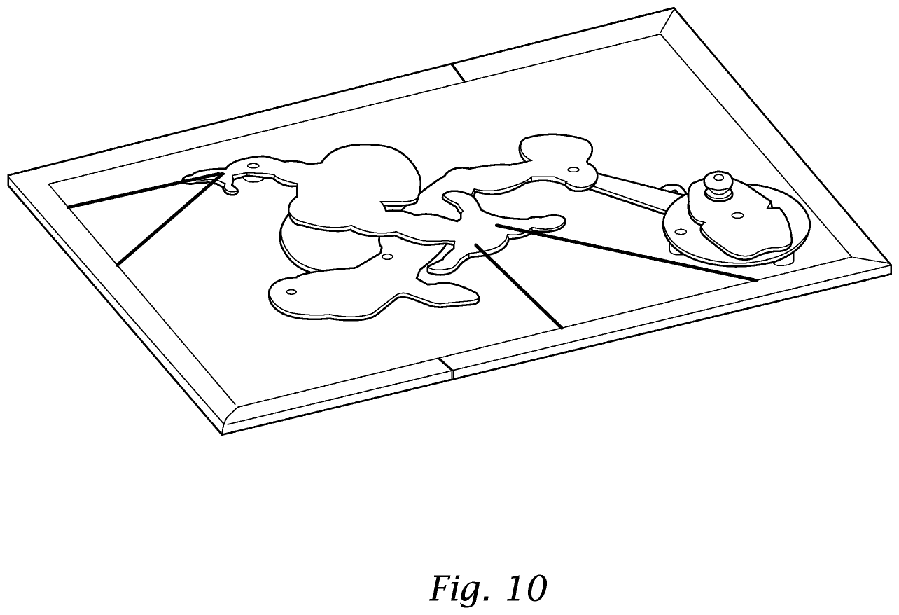

FIG. 10 shows that the plastic frame parts can be assembled around all the edges of the assembled puzzle to keep everything together. Some of the frames are made of two pieces that fit end-to-end, with all of the pointed ends in the corners. FIG. 10 shows that the frame slips over the puzzle and base board.

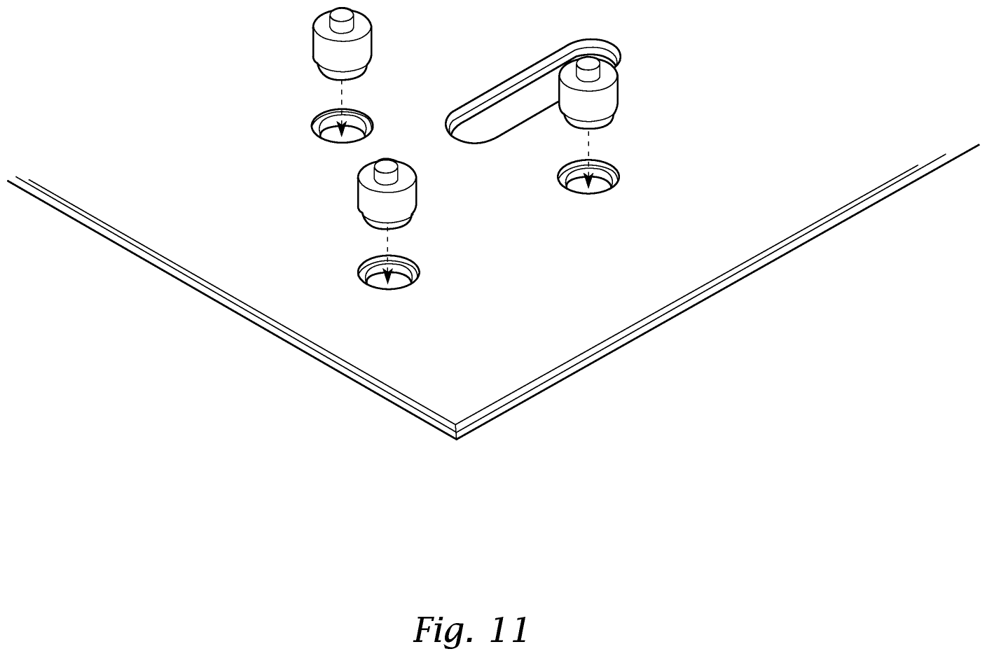

FIG. 11 shows the fitting of three crank deck standoffs. In the kit, these are included in the molded pieces bag. The large round ends of each of the three crank deck standoffs fit into the three circular holes in the lower right-hand corner of the puzzle. They pass through the puzzle pieces and fit snugly in the base board below. However, glue can be used on the mating parts (e.g., the rim of the large round end of the crank deck standoff which is fit into the hole) to make a more permanent assembly.

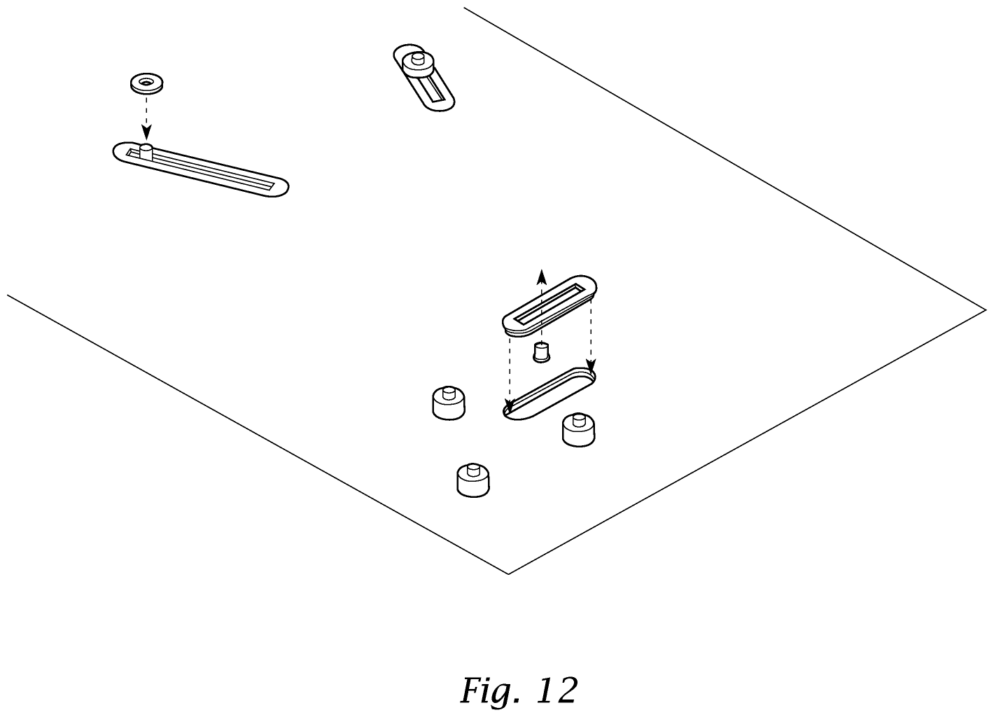

FIG. 12 shows three slider plates, spacers and pins. Check the slider plates to locate where each fits in the puzzle, but don't put them in yet. Instead, as shown in FIG. 12, assemble the pin from underneath the slider plate and push the slider plate all the way down into the base until the top is flat with the puzzle. Glue in the slider if desired. Follow these steps with each set of plate, spacer and pin, as shown in the figure.

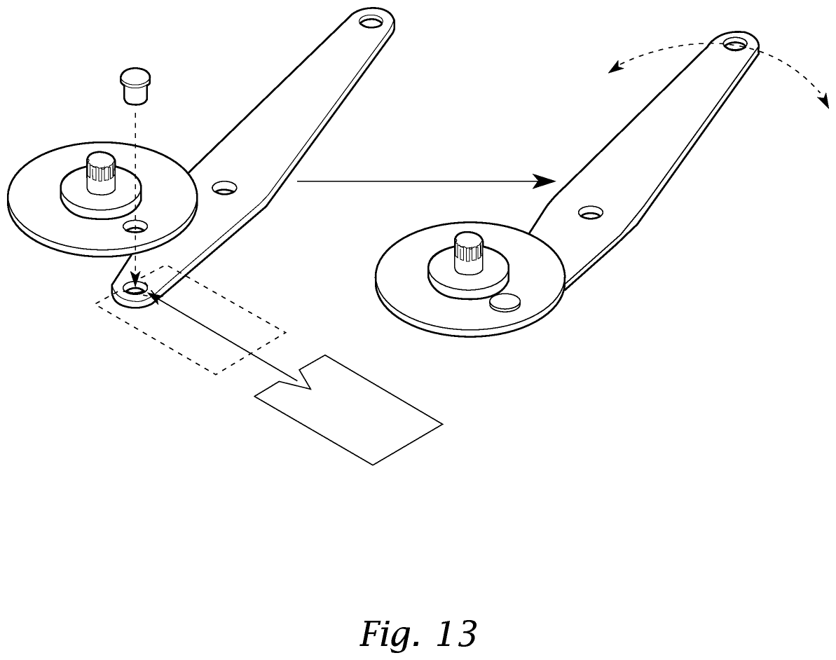

FIG. 13 shows assembly of a crank link onto a crank wheel with a pin. For best performance, when pressing in the pin, use a piece of cereal box cardboard to form a little gap, as shown. The pin may be glued into the wheel. Assemble the wheel and link assembly with the crank deck, as shown. Assemble the crank spacer onto the crank assemble, as shown, using the cardboard gapping method described earlier. Note: the crank spacer is a tight fit, and might require a little help from an adult. Test that all the pin joints rotate smoothly and adjust as necessary. Note: a “V” in the cardboard gapping spacer goes under the pin head during assembly.

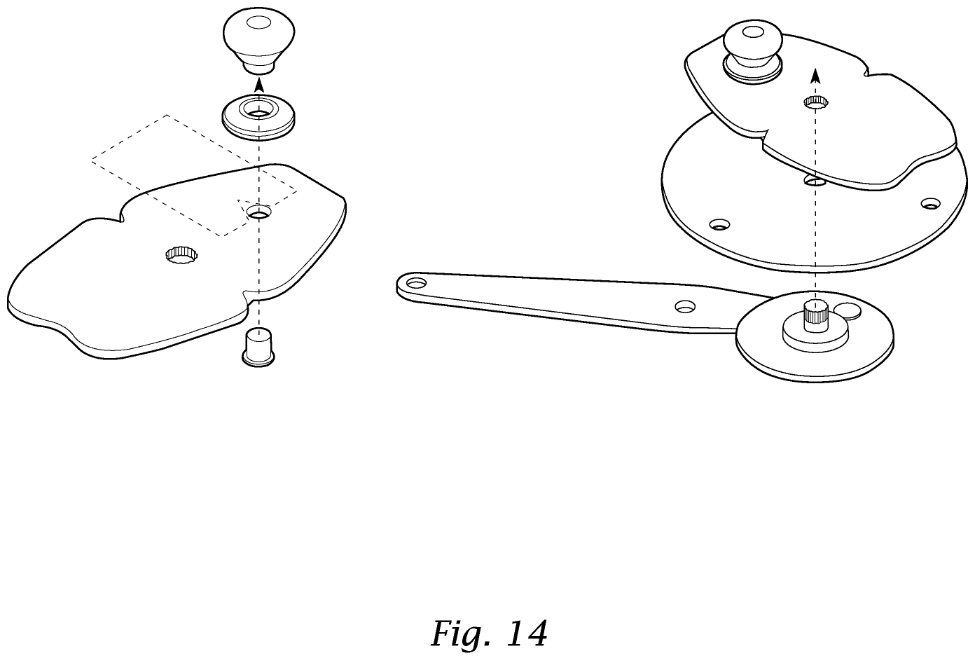

FIG. 14 shows how to assemble the crank knob with the spinner disk and pin. Assemble the spinner disk assembly onto the crank spacer as shown, making sure all the mating holes and pins align. Gluing this part is optional. Check that the crank assembly rotates smoothly and adjust if necessary.

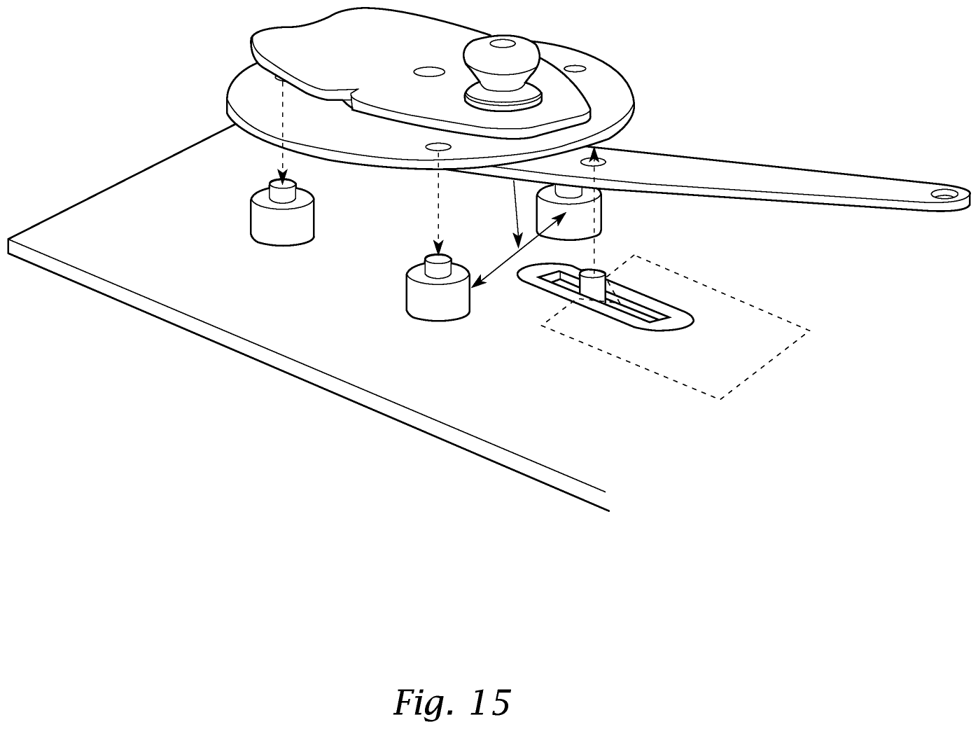

FIG. 15 shows mounting the crank/deck/link assembly on the three stand offs. Position the crank link over its mating slider. A crayon can be used to lubricate the inner edges of the pin slot. Press the pin into the link hole completely. Turning the crank knob should make the link go up and down and from left to right. If the mechanism binds, or feels clunky, check that all the puzzle pieces are firmly seated. If needed, put pieces of clear tape of the puzzle to keep it flat.

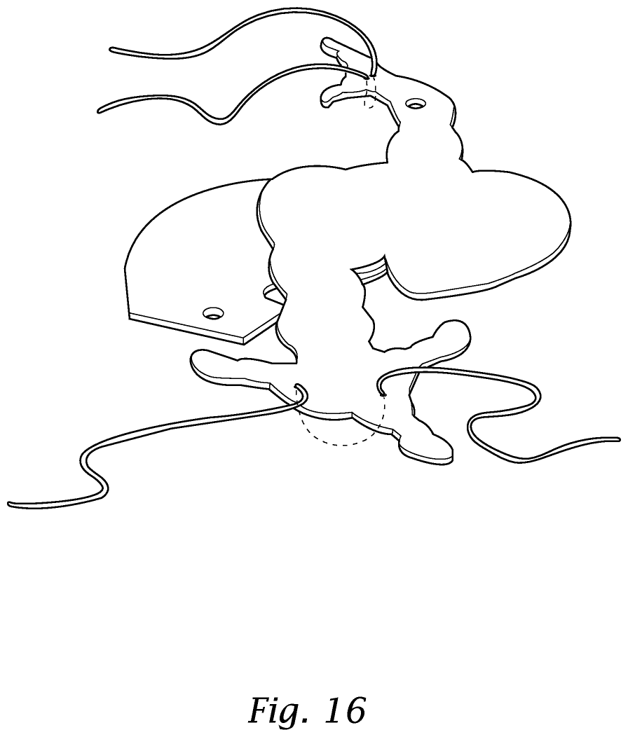

FIG. 16 shows the insertion of the web strings through the hand holes.

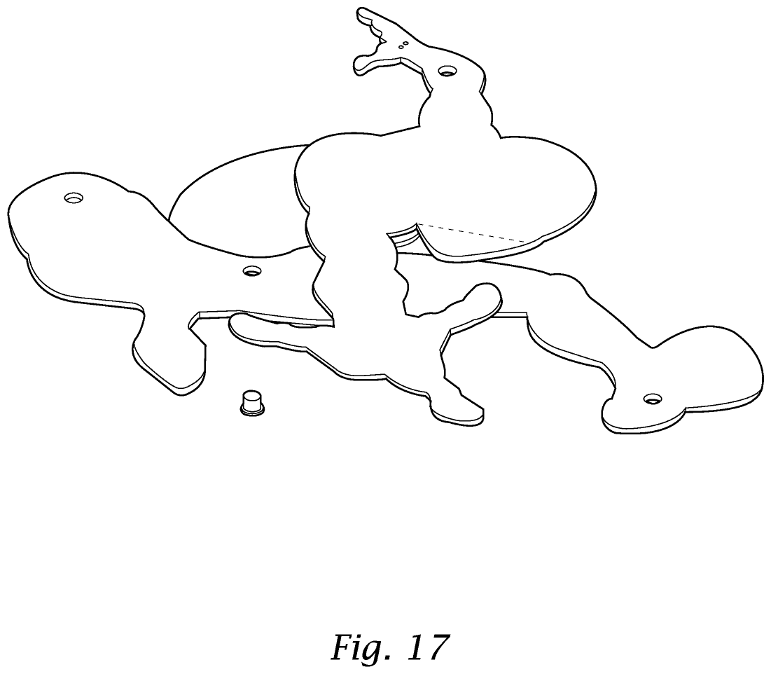

FIG. 17 shows the assembly of the figure's legs on top of the body and under the arm. Secure with pin as shown. The leg can pass freely under the character's chin. Bend up the chin very slightly if it binds (this way the chin will remain over the leg).

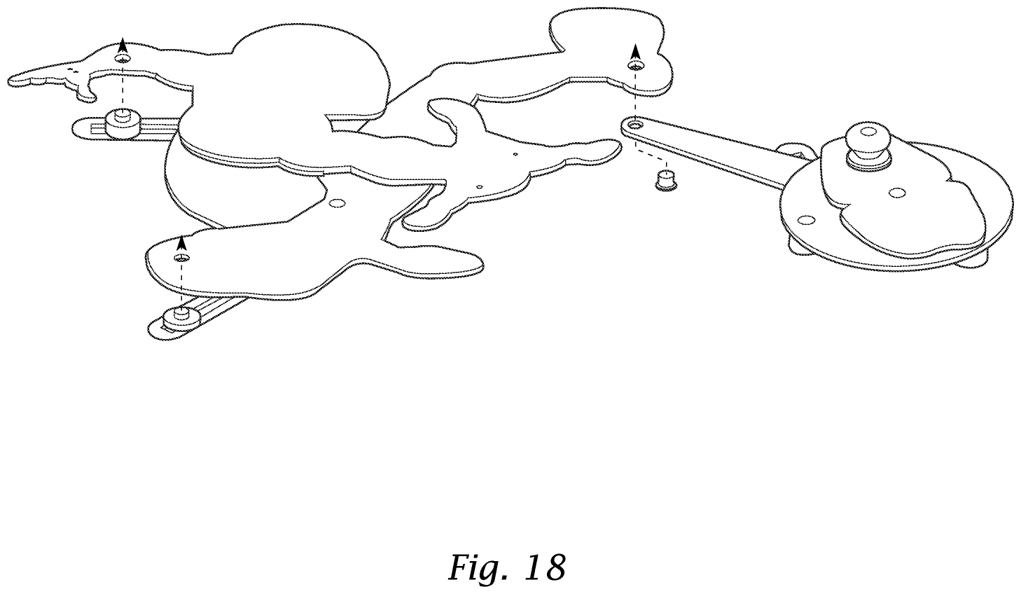

FIG. 18 shows inserting the link pin in the crank link from the underside. It also shows positioning the character onto the puzzle's surface and fitting the three pins in their respective holes. To ease any binding, a piece of cereal cardboard can be used to make a small gap under the heads of the pins.

Additional descriptions of some embodiments of the invention include:

This invention offers puzzle solvers an added reward at completion, namely; additional parts and components, layered on top and/or beneath the jigsaw layer, assembled and interconnected to create an operable, animated scene.

The invention might claim a jigsaw puzzle that incorporates some of the following: a plurality of added layers or partial layers, beneath or on top of the jigsaw layer, wherein there is a possibility to attach additional structural and mechanical components to the puzzle through openings in the jigsaw layer; a system of mechanical parts for animating jigsaw puzzles; mechanical linkage components with pictorial outlines.

FIG. 1 shows a jigsaw puzzle tableau 1 consisting of a plurality of interlocking puzzle pieces 2, the tableau having a plurality of additional layers typified by 3, 4, 5, 6, 12, 21 the added layers comprising the components of an operable animated mechanism. The mechanism is set in motion by operating a hand crank knob 22, which rotates planar component 21, which is further linked to components 3, 4, 10, 12.

FIG. 2 shows the jigsaw layer 1, has openings typified by 8, and through which mechanical and structural components typified by 7 communicate between other planar layers, such as 5 and 6. Those skilled in the art will recognize that the openings and mechanical or structural components can be of most any configuration or shape, such as those at 9 in FIGS. 3A, 3B and 4.

Mechanical components such as 7 are affixed to other layers 5, 6, either by interlocking features or adhesives thereby providing structural support for layers above or beneath the puzzle piece layer 2, while imparting independence from interference that might derive from perturbations in the otherwise planar surface of the puzzle piece layer 1, 2.

FIGS. 3A and 3B show a jigsaw puzzle with mechanically animated components 3, 4, 10, 12, 21 that typically integrate pivot connection points such as 13, 14, 15, 16, 17, thereby defining the animated components as mechanical linkages, said links typified by dashed lines 18, 19, 20.

The animated components 3, 5, 10, 12, 21 have planar outline shapes that conform to pictorial overlays on their surfaces, as shown in FIG. 2.

FIG. 4 details components 9, 23, 25, that enable compound motions of component 12, relative to the puzzle layers 1, 2, by a sliding pivot mechanism comprised of parts 9, 23, 24, 25. The slide plate 9 can be adhered to the substrate layer 6, and has a slot 22, through which protrudes a pin 23, that is fixed to the animated part 12. The pin 23 is captured beneath the plate 9 by means of a flange 24. A gap between the puzzle surface 1,2, and the underside of the animated part 12 is maintained by a spacer 25. It may be seen that the animated part 12 is able to move in both a longitudinal direction, parallel with the slot 22, as well as rotate about the central cylindrical axis of the pin 23. It can be seen by those skilled in the art that this arrangement of parts, consisting of a slotted plate with a captured pin can be modified in many ways, for the purposes of guiding a rotating part along a sliding path.

An embodiment of the invention includes a Puzzle Base Board (backer board) (optionally folded up), Jigsaw Puzzle Pieces, Molded Plastic Pieces (supports, etc.), Character Pieces (animated components), and Slide-on Frame Pieces (a Sticker Sheet is optional).

It is not strictly necessary to glue any parts together, since everything is made to be put together without it. However, moving parts can come apart over time, preventing the mechanism from working. Glue can help keep that from happening, and makes it possible to display the puzzle on a wall.

One embodiment of an animated puzzle kit can include some or all of the following: puzzle board, jigsaw puzzle pieces, molded plastic pieces (e.g., rivets, connecting rods, pins, spacers, supports, slide plates, knobs/cranks, etc.) character pieces, sticker sheet, and slide-on frame pieces. Assembly of the kit on a flat table surface of 3 feet by 2 feet is recommended. During assembly, it is can also be useful to use some or all of the following: scissors; white glue or glue stick; flat stick, tongue depressor or popsicle stick; clear tape; cereal box cardboard (a small flap); wax crayon; etc.

Disclosed and additional embodiments of the present invention include:
Mechanism activated Sound—Sound Chip with batteries, by pressing a button or movement of one or more animated components;
More than one Character on a puzzle moving—via crank (animating device);
More than one Character and objects moving—via crank (animating device);
Battery operated crank mechanism (animating device)—On/off switch;
Motion activated Battery Operated crank Mechanism (animating device)—Optic trigger;
Sound activated Battery Operated crank Mechanism (animating device);
Lenticular moving character pieces;
Glow in the Dark Character, Crank, Backerboard and/or Puzzle Pieces;
Sticker Sheet;
Backerboard with built in Easel Feature;
Easel that assembles separately and sticks to the back of the backerboard;
Die Cut Puzzle shapes to accommodate animated component Mechanism (with supports, connections, etc.);
Gears alone and/or together with disclosed movement mechanisms for moving animated components;
Using rechargeable and/or solar batteries for any battery components.

Although preferred embodiments of the present invention have been described herein it will be understood by those skilled in the art that the present invention should not be limited to the described preferred embodiments. Rather, various changes and modifications can be made within the spirit and scope of the present invention.

All of the material in these patent application documents are subject to copyright protection under the copyright laws of the United States and other countries. The copyright owner has no objection to the facsimile reproduction by anyone of the patent application documents, as it appears in official governmental records but, otherwise, all other copyright rights whatsoever are reserved.

1. An animated puzzle comprising:
At least two puzzle pieces and at least one animated component;
The at least two puzzle pieces being configured into shapes that fit together to form an assembled puzzle;
The assembled puzzle having at least one pre-determined pre-cut section for placement of the at least one animated component;
At least one animating device connected to the at least one animated component, whereby operation of the at least one animating device animates the at least one animated component.

2. The animated puzzle of claim 1, further comprising:
at least one support, the at least one support holding up the at least one animated component; and
the at least one support being adjacent the at least one pre-determined pre-cut section of the assembled puzzle.

3. The animated puzzle of claim 1, wherein the at least one animated component further comprises at least a first animated component and at least a second animated component, the at least first animated component being connected to the at least second animated component, whereby movement of the at least first animated component effects movement of the at least second animated component.

4. An animated puzzle comprising:
At least two puzzle pieces and at least one animated component;
The at least two puzzle pieces being configured into shapes that fit together to form an assembled puzzle;
A securing device, whereby puzzle pieces are secured to each other in the assembled puzzle when the animated component is animated;
The assembled puzzle having at least one pre-determined pre-cut section for placement of the at least one animated component;
At least one animating device connected to the at least one animated component, whereby operation of the at least one animating device animates the at least one animated component.

5. The animated puzzle of claim 4, further comprising:
at least one support, the at least one support being attached to the at least one animated component; and
the at least one support being adjacent the at least one pre-determined pre-cut section of the assembled puzzle.

6. The animated puzzle of claim 4, wherein the at least one animated component further comprises at least a first animated component and at least a second animated component, the at least first animated component being connected to the at least second animated component, whereby movement of the at least first animated component effects movement of the at least second animated component.

7. The animated puzzle of claim 4, wherein the securing device is a backer board, the backer board having a pre-defined border for holding the assembled puzzle.

8. The animated puzzle of claim 7, further comprising adhesive tape folded on top of the assembled puzzle along the pre-defined border of the backer board, from a reverse surface of the backer board, whereby a frame of adhesive tape is formed around the assembled puzzle.

9. The animated puzzle of claim 7, wherein the backer board is foldable into quarters, whereby it is smaller and less expensive for storage and transport.

10. The animated puzzle of claim 7, wherein the securing device is a slip-on frame comprised of a framing piece which slips over the assembled puzzle and the backer board to form a frame around the assembled puzzle and hold the assembled puzzle and the backer board together.

11. An animated puzzle kit comprising:
At least two puzzle pieces, at least one animated component, at least one animating device, and a backing sheet;
The at least two puzzle pieces for forming an assembled puzzle on the backing sheet;
The assembled puzzle having at least one pre-determined pre-cut section for placement of the at least one animated component;
and
The at least one animating device being connected to the at least one animated component, whereby operation of the at least one animating device animates the at least one animated component.

12. The animated puzzle kit of claim 11, further comprising at least one support;
the at least one support carrying the at least one animated component on the assembled puzzle, the at least one support being adjacent the at least one pre-determined pre-cut section of the assembled puzzle.

13. The animated puzzle kit of claim 11, further comprising at least two slip-on frame pieces;
The at least two slip-on frame pieces for slipping on the assembled puzzle and backing sheet, thereby holding together the assembled puzzle and backing sheet.

14. The animated puzzle kit of claim 11, further comprising, at least one connecting device;
The at least one animated component having at least a first animated component and a second animated component, the at least one connecting device for connecting at least the first animated component to at least the second animated component, whereby movement of the at least first animated component effects movement of the at least second animated component.
